(19) United States
(12) Patent Application Publication
(10) Pub. No.: US 2005/0286628 A1
(43) Pub. Date: Dec. 29, 2005

(54) Human visual system (HVS) filter in a discrete cosine transformator (DCT)

(76) Inventor: David Drezner, Raanana (IL)

Correspondence Address: STERNE, KESSLER, GOLDSTEIN & FOX PLLC, 1100 NEW YORK AVENUE, N.W., WASHINGTON, DC, 20005, US

(21) Appl. No.: 11/155,896

(22) Filed: Jun. 20, 2005

Related U.S. Application Data
(60) Provisional application No. 60/580,389, filed on Jun. 18, 2004.

(51) Int. Cl. H04B 1/66; H04N 11/02; H04N 11/04; H04N 7/12

(52) U.S. Cl. 375/240.2; 375/240.24; 375/240.12

(57) ABSTRACT

An encoder is described, the encoder comprising an analyzer operative to receive a video frame and provide classification information for a first pixel block in a first macroblock of said frame. The encoder further comprises a DCT transformator operative to perform DCT transformation upon the first pixel block, or upon residual information derived there from, thereby providing a plurality of first DCT coefficients. A rate controller is operative to receive said classification information from said analyzer and select DCT filtering parameters. The encoder further comprises a DCT filter operative to receive said DCT filtering parameters selection from said rate controller and implement said DCT filtering parameters upon said frame.

### CROSS REFERENCE TO RELATED APPLICATIONS

This application claims benefit to U.S. Provisional Application No. 60/580,389, filed Jun. 18, 2004, which is incorporated herein by reference.

### BACKGROUND OF THE INVENTION

1. Field of the Invention

The invention refers to an encoder, and an encoding method, and is generally related to image and video compression, and more particularely to bit-rate control therefor.

2. Background Art

In digital video and/or video/audio systems such as video-telephone, teleconference and digital television systems, a large amount of digital data is needed to define each video frame signal since a video line signal in the video frame signal comprises a sequence of digital data referred to as pixel values.

Since, however, the available frequency bandwidth of a conventional transmission channel is limited, in order to transmit the large amount of digital data therethrough, it is necessary to compress or reduce the volume of data through the use of various data compression techniques.

One of such techniques for encoding video signals for a low bit-rate encoding system is an object-oriented analysis-synthesis coding technique, wherein an input video image is divided into objects and three sets of parameters for defining the motions, the contours, and the pixel data of each object are processed through different encoding channels.

One example of such object-oriented coding scheme is the so-called MPEG (Moving Picture Experts Group) phase 4 (MPEG-4), which is designed to provide an audio-visual coding standard for allowing content-based interactivity, improved coding efficiency and/or universal accessibility in such applications as low-bit rate communications, interactive multimedia (e.g., games, interactive TV and the like) and surveillance (see, for instance, MPEG-4 Video Verification Model Version 2.0, International Organization for Standardization, ISO/IEC JTC1/SC29/WG11 N1260, Mar. 1996).

According to MPEG-4, an input video image is divided into a plurality of video object planes (VOP's), which correspond to entities in a bitstream that a user can have access to and manipulate. A VOP can be referred to as an object and represented by a bounding rectangle whose width and height may be chosen to be smallest multiples of 16 pixels (a macro block size) surrounding each object so that the encoder processes the input video image on a VOP-by-VOP basis, i.e., an object-by-object basis. The VOP includes color information consisting of the luminance component (Y) and the chrominance components (Cr, Cb) and contour information represented by, e.g., a binary mask.

Also, among various video compression techniques, the so-called hybrid coding technique, which combines temporal and spatial compression techniques together with a statistical coding technique, is known.

Most hybrid coding techniques employ a motion compensated DPCM (Differential Pulse Coded Modulation), two-dimensional DCT (Discrete Cosine Transform), quantization of DCT coefficients, and VLC (Variable Length Coding). The motion compensated DPCM is a process of estimating the movement of an object between a current frame and its previous frame, and predicting the current frame according to the motion flow of the object to produce a differential signal representing the difference between the current frame and its prediction.

Specifically, in the motion compensated DPCM, current frame data is predicted from the corresponding previous frame data based on an estimation of the motion between the current and the previous frames. Such estimated motion may be described in terms of two dimensional motion vectors representing the displacements of pixels between the previous and the current frames.

There have been two basic approaches to estimate the displacements of pixels of an object. Generally, they can be classified into two types: one is a block-by-block estimation and the other is a pixel-by-pixel approach.

In the pixel-by-pixel approach, the displacement is determined for each and every pixel. This technique allows a more exact estimation of the pixel value and has the ability to easily handle scale changes and non-translational movements, e.g., scale changes and rotations, of the object. However, in the pixel-by-pixel approach, since a motion vector is determined at each and every pixel, it is virtually impossible to transmit all of the motion vectors to a receiver.

Using the block-by-block motion estimation, on the other hand, a current frame is divided into a plurality of search blocks. To determine a motion vector for a search block in the current frame, a similarity calculation is performed between the search block in the current frame and each of a plurality of equal-sized reference blocks included in a generally larger search region within a previous frame. An error function such as the mean absolute error or mean square error is used to carry out a similarity measurement between the search block in the current frame and the respective reference blocks in the search region of the previous frame. And the motion vector, by definition, represents the displacement between the search block and a reference block which yields a minimum error function.

As a search region, for example, a relatively large fixed-sized region around the search block might be used (the search block being in the center of the search region).

Another option is to—preliminarily—predict the motion vector for a search block on the basis of one or several motion vectors from surrounding search blocks already—finally—determined, and to use as a search region, for example, a relatively small region not around the center of search block, but around the tip of the—preliminarily predicted—motion vector (the tip of the predicted motion vector being in the center of the search region).

Standards bodies such as the Moving Picture Experts Group (MPEG) and the Joint Photographic Experts Group (JPEG) specify general methodologies and syntax for generating standard-compliant files and bit streams. Generally, such bodies do not define a specific algorithm needed to produce a valid bit stream, according encoder designers great flexibility in developing and implementing their own specific algorithms in areas such as image pre-processing, motion estimation, coding mode decisions, scalability, and rate control. This flexibility fosters development and implementation of different algorithms, thereby resulting in product differentiation in the marketplace. However, a common goal of encoder designers is to minimize subjective distortion for a prescribed bit rate and operating delay constraint.

In the area of bit-rate control, MPEG and JPEG also do not define a specific algorithm for controlling the bit-rate of an encoder. It is the task of the encoder designer to devise a rate control process for controlling the bit rate such that the decoder input buffer neither overflows nor underflows. A fixed-rate channel is assumed to carry bits at a constant rate to an input buffer within the decoder. At regular intervals determined by the picture rate, the decoder instantaneously removes all the bits for the next picture from its input buffer. If there are too few bits in the input buffer, i.e., all the bits for the next picture have not been received, then the input buffer underflows resulting in an error. Similarly, if there are too many bits in the input buffer, i.e., the capacity of the input buffer is exceeded between picture starts, then the input buffer overflows resulting in an overflow error. Thus, it is the task of the encoder to monitor the number of bits generated by the encoder, thereby preventing the overflow and underflow conditions.

One common method for bit-rate control in MPEG and JPEG encoders, which employ Discrete Cosine Transformation (DCT), involves modifying the quantization step. However, it is well known that modifying the quantization step affects the distortion of the input video image. The distortion of the lower DCT coefficients causes “blockiness,” while distortion of the higher DCT coefficients causes blurriness. It is well know that the Human Visual System (HVS) prefers greater distortion for higher frequency DCT components than for lower frequency components. This is because, generally speaking, most image content is in the low frequency range. This is due to a high correlation between adjacent pixels. Unfortunately, known MPEG and JPEG encoders that attempt to control bit-rate by modifying the quantization step do not distribute the distortion between low and high frequency coefficients in a way that is optimal for the HVS. For example, when using uniform quantizers, uniform distortion is caused among low and high frequency components. This is not optimal for HVS which prefers more distortion among high frequency components rather than among low frequency components. By contrast, quantization matrices cause more distortion among high frequency components than among low frequency components, which HVS prefers. However, quantization matrices operate on a per-coefficient basis (i.e., point process) that provides only a rough HVS optimization.

In general, compression techniques such as e.g. Variable Length Coding (VLC) take advantage of the fact that in natural video, most image content is in the low frequency range. This is due to a high correlation between adjacent pixels. In MPEG and JPEG processing, DCT coefficients are ordered in a “ZigZag” scan and numbered 0-63 in ascending order. Both uniform quantizers and quantization matrices attempt to create sequences of successive zeroes at the end of the scan, since the longer the zero sequence, the fewer variable length coding bits are needed for coding the block, especially when long sequences of zeroes appear at the end of the “ZigZag” scan order. However, neither uniform quantizers nor quantization matrices ensure the creation of sequences of successive zeroes in a deterministic way.

Another method for controlling the bit rate involves discarding high DCT coefficients and only transmitting low DCT coefficients. This method is applied during rate control only when the output bit rate is higher than the target bit rate. This will produce visible artifacts, such as a strong “blurriness effect,” in the decoded video image, which human viewers generally find unacceptable. This type of artifact requires that some blocks within a picture be coded more accurately than others. In particular, blocks with less activity require fewer bits than blocks with high activity.

Further, the US 2003/0223492 describes an encoder with a discrete cosine transformator (DCT) for performing DCT transformation upon—one single—pixel block in—one single—macroblock of an image or video frame.

### SUMMARY OF THE INVENTION

A system and/or method for encoding data, substantially as shown in and/or described in connection with at least one of the figures, as set forth more completely in the claims.

### BRIEF DESCRIPTION OF THE DRAWINGS/FIGURES

The above and other features, aspects and advantages of the present invention will be more fully understood when considered with respect to the following detailed description, appended claims and accompanying drawings, wherein:

FIG. 1 is a simplified block diagram illustration of an encoding system, constructed and operative in accordance with a preferred embodiment of the present invention;

FIG. 2 is a simplified flowchart illustration of an exemplary method of operation of the system of FIG. 1, operative in accordance with a preferred embodiment of the present invention;

FIG. 3 is a simplified flowchart illustration of a preferred method of operation of analyzer 112 of FIG. 1, operative in accordance with a preferred embodiment of the present invention;

FIG. 4 is a simplified flowchart illustration of a preferred method of operation of rate controller 114 of FIG. 1, operative in accordance with a preferred embodiment of the present invention;

FIG. 5 is a simplified conceptual illustration of an exemplary DCT coefficient matrix, useful in understanding the present invention; and

FIG. 6 is a simplified conceptual illustration of an exemplary DCT coefficient matrix used for interlaced coding.

### DETAILED DESCRIPTION OF THE INVENTION

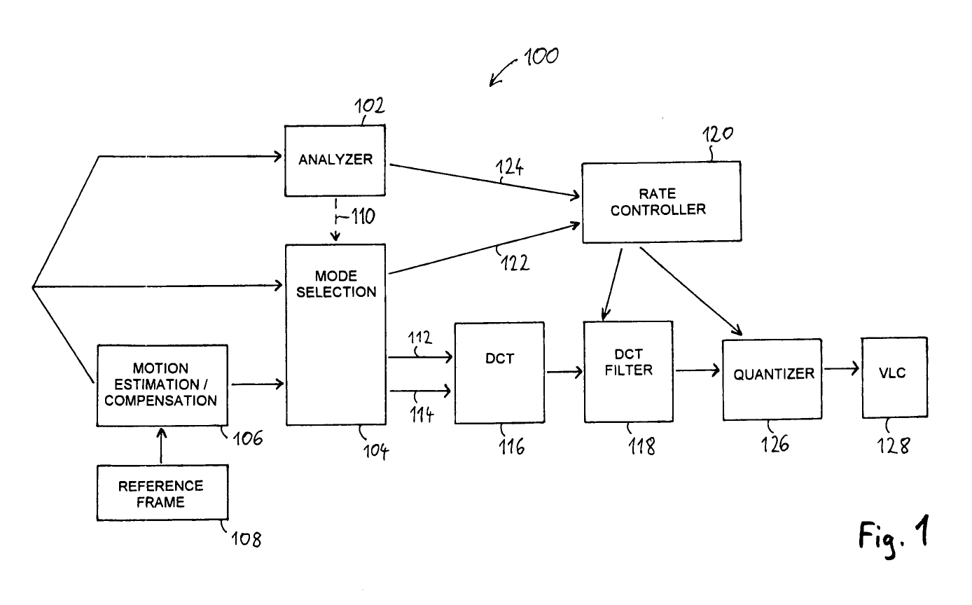

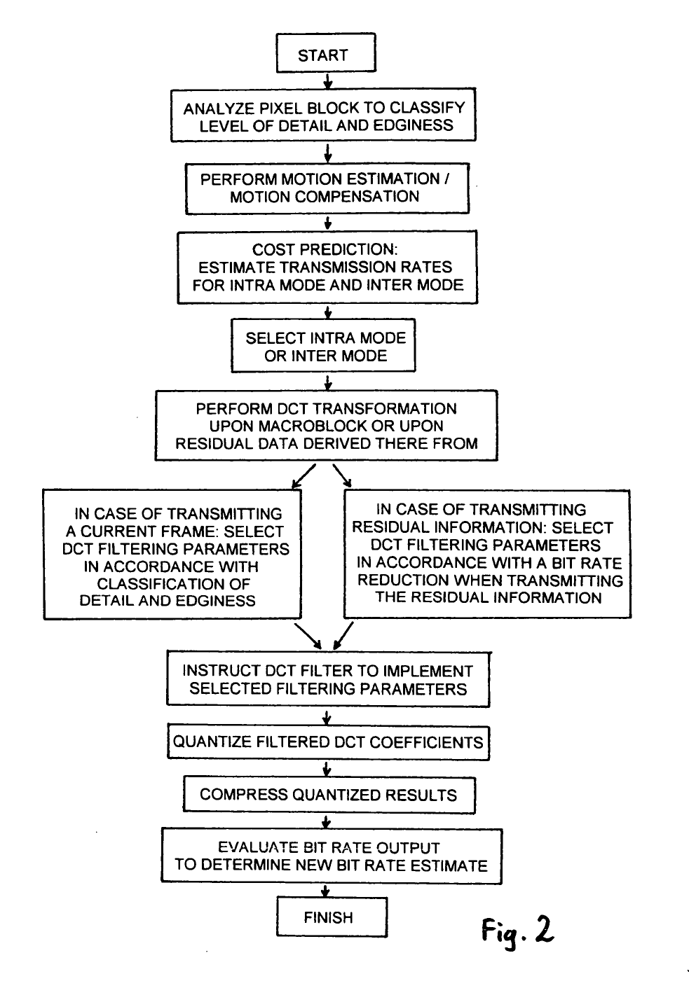

Reference is now made to FIG. 1, which is a simplified block diagram illustration of an encoding system, constructed and operative in accordance with a preferred embodiment of the present invention, and additionally to FIG. 2, which is a simplified flowchart illustration of an exemplary method of operation of the system of FIG. 1, operative in accordance with a preferred embodiment of the present invention. In the system of FIG. 1 and method of FIG. 2, an encoder 100, such as may be used for encoding MPEG video, includes an analyzer 102 which receives blocks of 8*8 pixels of a video frame.

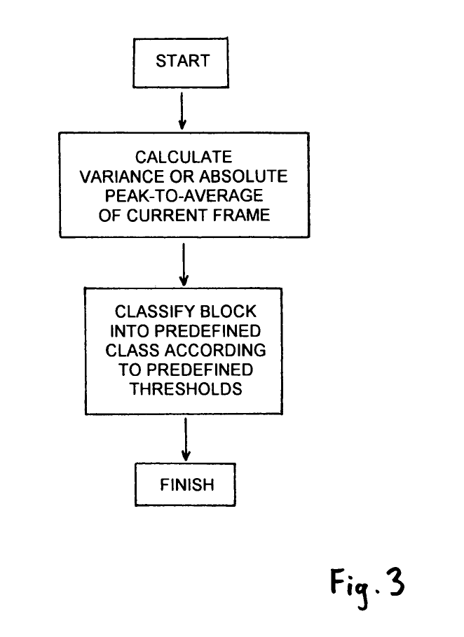

Analyzer 102 analyzes the pixel data to determine the level of detail and “edginess” (i.e., extent of edges) of each block in a macroblock, and classifies the macroblock accordingly. A preferred method of operation of analyzer 112 is described in greater detail hereinbelow with reference to FIG. 3. Once analyzer 102 has processed one or more all of the blocks in a frame it provides the classification information per block to a mode selection unit 104.

Pixel blocks of the current frame are further provided to a motion estimation/compensation unit 106. Motion of a video sequence is tracked by defining a reference informationframe 108, and by determining the respective deviation of each macroblockframe relative to the reference informationframe 108. For each macroblockframe, the difference between the macroblockframe's pixel values and the pixel values of the reference informationframe is determined. Thus, so-called residual information is derived, which specifies the macroblockframe's deviation from the reference informationframe 108. For example, the residual information might be obtained by subtracting pixel values of the reference informationframe 108 from the current macroblockframe's pixel values.

Now, either the current macroblockframe or the residual information derived from the current macroblockframe may be codedtransmitted. CodingTransmission of the current macroblockframe itself will furtheron be referred to as “intra mode”, and codingtransmission of residual information will be referred to as “inter mode”.

Before deciding whether to codetransmit the current macroblockframe itself or the residual information derived there from, respective bit rates for these two possible coding transmission modes are estimated. Both in inter mode and intra mode, tThe bit rate required for codingtransmitting the current macroblockframe strongly depends on the level of detail and edginess: The higher the current macroblockframe's level of detail and edginess, the more high order DCT coefficients will be needed for representing the macroblockframe's pixel values. Hence, the higher the level of detail and edginess, the more bandwidth will be required for codingtransmitting the current macroblockframe in an intra mode or in inter mode.

The mode selection unit 104 receives classification information 110 from the analyzer 102 and estimates a bit rate for intra mode codingtransmission. Additionally, the mode selection unit 104 estimates the bit rate required for codingtransmitting residual information derived from the current macroblockframe. Then, the estimated bit rates for intra mode and inter mode coding transmission are compared. The mode selection unit 104 selects either intra mode or inter mode as being the most favourable transmission coding mode. In inter mode, the motion vector coding oerhead is taken into account.

In dependence on the selected mode, either pixel data 112 of the current macroblockframe or residual information 114 is forwarded to a DCT transformator 116. The DCT transformator 116 performs DCT transformation upon the pixel data or upon the residual information and generates a matrix of DCT coefficients. Optionally, the encoder 100 might comprise a zig-zag matrix-to-vector converter (not shown) adapted for converting the matrix of DCT coefficients into a one-dimensional vector of DCT coefficients by traversing the matrix in zig-zag order using conventional techniques.

Next, the DCT coefficients determined by the DCT transformator 116 are forwarded to a DCT filter 118 adapted for filtering the DCT coefficients, with the filtering parameters of the DCT filter 118 being set by a rate controller 120. The rate controller 120 receives information 122 about the codingtransmission mode from mode selection unit 104. Furthermore, rate controller 120 receives classification information 124 indicating a level of detail and edginess from the analyzer 102.

If a current frame is transmitted (intra mode), rRate controller 120 will select appropriate DCT filtering parameters in accordance with the classification information 124, whereby the higher the level of detail and edginess, the less DCT filtering will be performed. Rate controller 120 instructs DCT filter 118 to implement the selected filtering parameters accordingly.

In case of transmitting residual information (inter mode), rate controller 120 will vary the extent of filtering in dependence on a reduction ratio indicating by how much the bit rate will be reduced when transmitting the residual information instead of the current frame itself. In case of a large reduction, a large extent of filtering will be appropriate, because only noise will be removed.

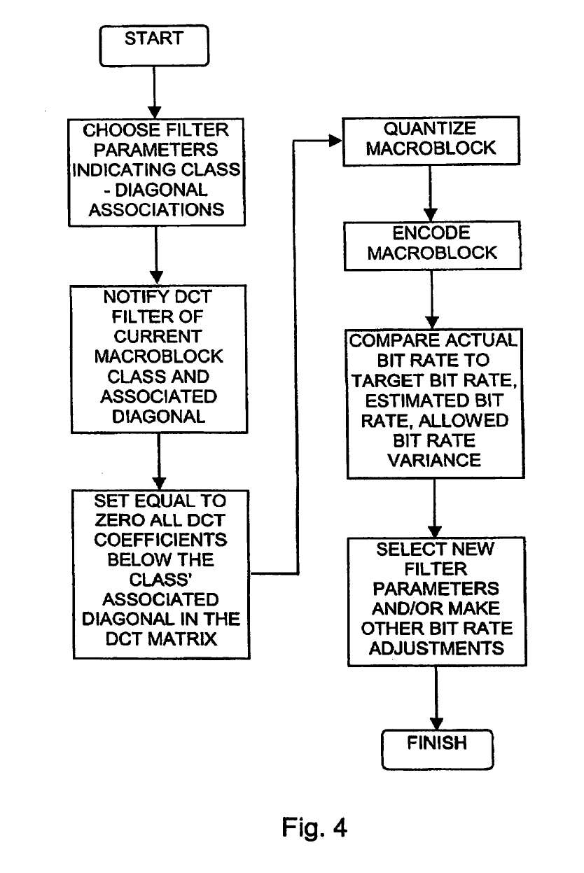

The way the DCT filtering is performed is described in greater detail hereinbelow with reference to FIG. 4. The filtered DCT coefficients obtained at the output of DCT filter 118 are then quantized at a quantizer 126. The quantized results are compressed, such as at a variable length coder (VLC) 128. The bit rate at the output of VLC 128 may be fed back to rate controller 120 so that rate controller 120 may adjust its bit rate estimation. Rate controller 120 may also control quantizer 126 to affect the encoder bit rate using conventional techniques.

Reference is now made to FIG. 3, which is a simplified flowchart illustration of a preferred method of operation of analyzer 102 of FIG. 1, operative in accordance with a preferred embodiment of the present invention. In the method of FIG. 3, the analyzer 102 is operative to determine a measure of the level of detail and edginess of a block of pixels. For example, the analyzer 102 might determine a variance of the pixel values in the pixel block, whereby a high variance indicates a high level of detail. Additionally or alternatively, the analyzer 102 might determine an absolute peak-to-average value of the pixel values in the pixel block, with a large peak-to-average value indicating a high level of detail and edginess.

Using a series of thresholds for the various variance values and/or peak-to-average values, the block is then classified into a number of different classes, with each of the n classes corresponding to a certain level of detail and edginess.

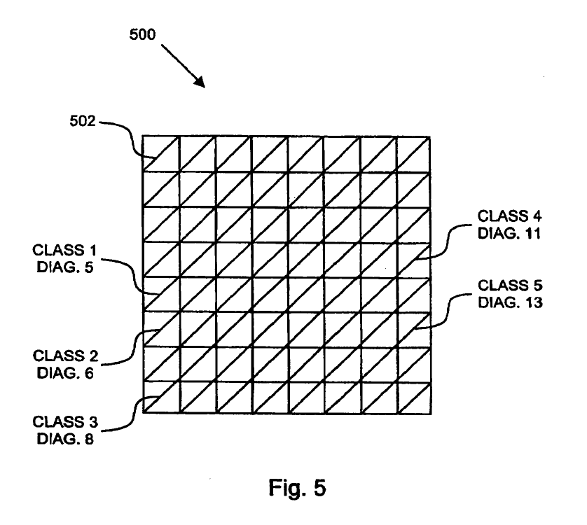

Reference is now made to FIG. 4, which is a simplified flowchart illustration of a preferred method of operation of rate controller 120 of FIG. 1, operative in accordance with a preferred embodiment of the present invention. In the method of FIG. 4, a set of filter parameters is chosen indicating per class the DCT coefficient matrix diagonal past which the coefficients are set equal to zero. By way of illustration, FIG. 5 shows a DCT coefficient matrix of an exemplary block 500 whose coefficients are represented as a series of diagonals 502. A set of filter parameters might, for example, assign class 1 to diagonal 5 (i.e., the fifth diagonal starting with the AC coefficient), class 2 to diagonal 6, class 3 to diagonal 8, class 4 to diagonal 11, and class 5 to diagonal 13. For example, were a block classified as class 1 using the method of FIG. 3, the coefficients of diagonals 6-15 would be set equal to zero, whereas were the block classified as class 3, the coefficients of diagonals 9-15 would be set equal to zero. Rate controller 120 then notifies DCT filter 118 of the class to which the current block belongs and of the diagonal associated with the class. DCT filter 118 then sets equal to zero all DCT coefficients below its class's associated diagonal as the coefficients would appear in the original DCT matrix. The macroblock is then processed normally by quantizer 126 and VLC 128.

It will be appreciated that, by zeroing the high-order DCT coefficients from a given diagonal in the DCT matrix, the present invention provides uninterrupted strings of zero values that saves bits and lowers entropy. As a result, the quantizer step may be lowered, resulting in a lower distortion at the low-order diagonals that is optimal for the HVS. A tradeoff between distortion on the high-order and low-order DCT coefficients may be managed to reach optimal HVS input. By lowering the distortion at the low diagonals/coefficients, block artifacts caused by the low diagonal/coefficient distortion is also reduced.

New filter parameters may be selected based on analysis of the actual bit rate at VLC 128 as compared with the target bit rate, the estimated bit rate, and an allowed bit rate variance. Additionally or alternatively, the quantization step may be adjusted using known techniques, frames may be dropped, and/or other known bit rate adjustment measures may be taken.

When transmitting frames according to interlaced coding, transmission of two video fields corresponds to transmission of one video frame. For example, in the standard PAL, video transmission is effected at a field rate of 50 fields per second, which corresponds to a rate of 25 frames per second. Dependent on the way the video sequences are acquired, there might be a small time shift between two fields that correspond to one frame. As a consequence, certain types of visible artefacts like e.g. comb artefacts appear when displaying the video sequence.

In interlaced coding, every second line of a frame is transmitted. As a consequence, when considering the probabilities of different spatial frequencies for natural video frames, there is generally more activity in the vertical direction's high spatial frequency range than in the horizontal direction's high spatial frequency range. Therefore, in interlaced coding, this respect, for removing visible artefacts related to interlaced coding, it is advantageous to treat vertical DCT coefficients differently than horizontal DCT coefficients. Preferably, in interlaced coding, horizontal DCT coefficients are set to zero earlier than vertical DCT coefficients.

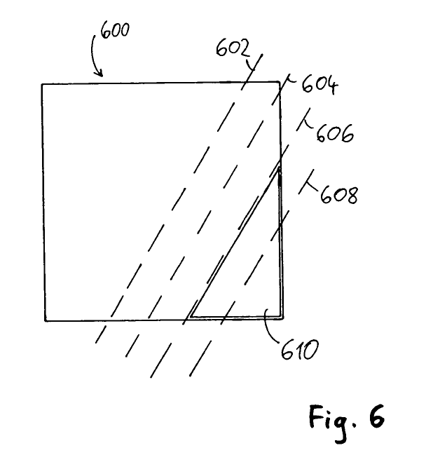

A corresponding embodiment of the invention is shown in FIG. 6. A DCT coefficient matrix 600 related to interlaced coding is shown.

Furthermore, a set of lines 602, 604, 606, 608 is shown, with each of said lines corresponding to a certain class of detail and edginess. Filtering of the DCT coefficient matrix is performed by setting to zero all the DCT coefficients below a respective one of the tilted lines 602, 604, 606, 608. Thus, it is accomplished that horizontal DCT coefficients are set to zero earlier than vertical DCT coefficients.

For example, if the classification information indicates to use line 606 for DCT filtering, the DCT coefficients in the triangular area 610 will be set to zero, with the triangular area 610 being a non-isosceles triangle.

It will be appreciated that rate controller 120 may implement a variable quantization factor in a frame for each block, while the stream may have one quantization value per frame. This is particularly advantageous for H.261, H.263 and MPEG-4 simple profile media streams where only one quantization value is allowed per frame. Since H.261, H.263 and MPEG-4 simple profile are targeted for low bit-rate applications, using DCT filter 118 to apply a variable quantization factor is advantageous. It will be further appreciated that a region of interest (ROI) may be set for each frame, thereby allowing a greater or lesser degree of blurriness to be defined within the ROI or without, such as by having DCT filter 118 implement different DCT filtering parameters within the ROI and without.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

Summarized, an encoder is provided comprising

an analyzer operative to receive a video frame and provide classification information for a first pixel block in a first macroblock of said frame;

a DCT transformator operative to perform DCT transformation upon the first pixel block, or upon residual information derived there from, thereby providing a plurality of first DCT coefficients;

a rate controller operative to receive said classification information from said analyzer and select DCT filtering parameters; and

a DCT filter operative to receive said DCT filtering parameters selection from said rate controller and implement said DCT filtering parameters upon said frame.

Advantageously, in addition to what was described above, said analyzer is operative to determine a level of detail and edginess of said first pixel block and classify the first pixel block in accordance with said determination. The pixel values themselves are used for determining the level of edginess.

In a further preferred embodiment, the analyzer is operative to determine at least one of a variance and an absolute peak-to-average value of the pixels of the first pixel block. The higher the variance, the higher the amount of detail. Similarily, also the peak-to-average value indicates edginess of the pixel block.

Advantageously, in addition to what was described above, the encoder further comprises a motion estimation unit operative to determine a reference informationframe, and to derive the residual information from the first pixel block a current frame using the reference informationframe.

In a preferred embodiment, the encoder further comprises a mode selection unit operative to compare an estimated transmission rate for codingtransmitting the first macroblocka current frame in an intra mode with an estimated transmission rate for codingtransmitting residual information in an inter mode.

Advantageously, in addition to what was described above, the mode selection unit is operative to select, in dependence on estimated transmission rates, coding transmitting either the first macroblock in an intra modea current frame, or residual information derived there from in an inter mode. There exist cases where it is better to codetransmit the first macroblockframe itself, e.g. in case the macroblockframe mainly comprises new information. In other cases, it is better to codetransmit the residual information.

Preferably, in case of codingtransmitting the first macroblocka current frame, the rate controller is operative to vary the DCT filtering parameters in dependence on the classification information, said classification information indicating a the frame's level of detail and edginess. Thus, an adaptivce DCT filtering is implemented.

Further preferably, in case of coding the first macroblocktransmitting a current frame, the rate controller is operative to vary the DCT filtering parameters in dependence on the classification information, wherein the higher the level of detail and edginess, the lower the extent of DCT filtering will be. In case the level of detail and edginess is rather high, the high order DCT coefficients must not be removed. Therefore, in this case, the extent of filtering is kept small.

In a preferred embodiment, in case of codingtransmitting residual information, the rate controller is operative to vary the DCT filtering parameters in dependence on the classification information, said classification information indicating a level of detail and edginess the rate controller is operative to vary the extent of DCT filtering in dependence on how much the transmission rate is reduced when transmitting the residual information instead of the current frame. If there is a considerable reduction, there will be a lot of noise. By setting the high order DCT coefficients to zero, this noise can be removed without any significant loss of quality.

Advantageously, in addition to what was described above, said DCT filter is operative to set equal to zero all high order DCT coefficients of a DCT coefficient matrix below a diagonal associated with a desired extent of DCT filtering

Advantageously, in addition to what was described above, the DCT filter is operative to receive information indicating whether progressive coding or interlaced coding is used, wherein in case of interlaced coding, the area of high order DCT coefficients that are set to zero is chosen such that different thresholds are utilized for zeroing the vertical and the horizontal DCT coefficients. In case of interlaced coding, two video fields are transmitted per video frame. In this case, filtering of the horizontal DCT coeffients should be effected in a different way than filtering of the vertical DCT coefficients. In particular, in order to avoid visible artefacts, the horizontal DCT coefficients should be set to zero earlier than the vertical DCT coefficients.

In a preferred embodiment, the DCT filter providing filtered DCT coefficients; the encoder further comprising a quantizer operative to quantize said filtered DCT coefficients; and a compressor operative to compress said quantized results.

Advantageously, in addition to what was described above, the DCT transformator in addition performs DCT transformation upon a second pixel block in the first macroblock of said frame, and/or performs DCT transformation upon a first pixel block in a second macroblock of said frame, thereby providing a plurality of second DCT coefficients.

Advantageously, in addition to what was described above, the DCT transformator might perform DCT transformation upon a third pixel block in the first macroblock of said frame, and/or might perform DCT transformation upon a first pixel block in a third macroblock of said frame, and/or might perform DCT transformation upon a second pixel block in the second macroblock of said frame, thereby providing a plurality of third DCT coefficients, etc., etc.

In a further embodiment, the analyzer is operative to receive said first, second, and/or third DCT coefficients (and/or further DCT coefficients related to further pixel blocks and/or to further macroblocks), and to provide classification information for said first and/or second and/or third (and/or further) macroblock.

The rate controller might be operative to receive said first and/or second and/or third (and/or further) classification information from said analyzer and select DCT filtering parameters; and the DCT filter might be operative to receive said DCT filtering parameters selection from said rate controller and implement said DCT filtering parameters upon said frame.

Hence, the algorithm might advantageously not only be applied to—one single—pixel block in—one single—macroblock of an image or video frame, but to surrounding (macro)blocks also. Thereby, noise reduction, luminance and filtering of the image/video data might be improved.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. An encoder comprising
an analyzer operative to receive a video frame and provide classification information for a first pixel block in a first macroblock of said frame;
a DCT transformator operative to perform DCT transformation upon the first pixel block, or upon residual information derived there from, thereby providing a plurality of first DCT coefficients;
a rate controller operative to receive said classification information from said analyzer and select DCT filtering parameters; and
a DCT filter operative to receive said DCT filtering parameters selection from said rate controller and implement said DCT filtering parameters upon said frame.

2. The encoder of claim 1, wherein said analyzer is operative to determine a level of detail and edginess of said first pixel block and classify the first pixel block in accordance with said determination.

3. The encoder of claim 1, wherein the analyzer is operative to determine at least one of a variance and an absolute peak-to-average value of the pixels of the first pixel block.

4. The encoder of claim 1, further comprising a motion estimation unit operative to determine a reference informationframe, and to derive the residual information from the first pixel block a current frame using the reference informationframe.

5. The encoder of claim 1, further comprising a mode selection unit operative to compare an estimated transmission rate for codingtransmitting the first macroblock a current frame in an intra mode with an estimated transmission rate for codingtransmitting residual information in an inter mode.

6. The encoder of claim 1, wherein the mode selection unit is operative to select, in dependence on estimated transmission rates, codingtransmitting either the first macroblocka current frame in an intra mode, or residual information derived there from in an inter mode.

7. The encoder of claim 5, wherein, in case of codingtransmitting the first macroblock, a current frame, the rate controller is operative to vary the DCT filtering parameters in dependence on the classification information, said classification information indicating the frame's a level of detail and edginess.

8. The encoder of claim 5, wherein, in case of codingtransmitting the first macroblock, a current frame, the rate controller is operative to vary the DCT filtering parameters in dependence on the classification information, wherein the higher the level of detail and edginess, the lower the extent of DCT filtering will be.

9. The encoder of claim 5, wherein, in case of codingtransmitting residual information, the rate controller is operative to vary the DCT filtering parameters in dependence on the classification information, said classification information indicating a level of detail and edginess.
the rate controller is operative to vary the extent of DCT filtering in dependence on how much the transmission rate is reduced when transmitting the residual information instead of the current frame.

10. The encoder of claim 1, wherein said DCT filter is operative to set equal to zero all high order DCT coefficients of a DCT coefficient matrix below a diagonal associated with a desired extent of DCT filtering.

11. The encoder of claim 1, wherein the DCT filter is operative to receive information indicating whether progressive coding or interlaced coding is used, wherein in case of interlaced coding, the area of high order DCT coefficients that are set to zero is chosen such that different thresholds are utilized for zeroing the vertical and the horizontal DCT coefficients.

12. The encoder of claim 1, the DCT filter providing filtered DCT coefficients; the encoder further comprising a quantizer operative to quantize said filtered DCT coefficients; and a compressor operative to compress said quantized results.

13. The encoder of claim 1, wherein the DCT transformator is operative to additionally perform DCT transformation upon a second pixel block in the first macroblock of said frame, thereby providing a plurality of second DCT coefficients.

14. The encoder of claim 13, wherein the DCT transformator is operative to additionally perform DCT transformation upon a third pixel block in the first macroblock of said frame, thereby providing a plurality of third DCT coefficients.

15. The encoder of claim 1, wherein the DCT transformator is operative to additionally perform DCT transformation upon a first pixel block in a second macroblock of said frame, thereby providing a plurality of second DCT coefficients.

16. The encoder of claim 15, the analyzer being operative to receive said first pixel block in the second macroblock, and provide classification information for said second macroblock;
the rate controller being operative to receive said first and second classification information from said analyzer and select DCT filtering parameters; and
the DCT filter being operative to receive said DCT filtering parameters selection from said rate controller and implement said DCT filtering parameters upon said frame.

17. The encoder of claim 15, wherein the DCT transformator is operative to additionally perform DCT transformation upon a second pixel block in the second macroblock of said frame, thereby providing a plurality of third DCT coefficients.

18. An encoder method comprising:
providing classification information for a first pixel block in a first macroblock of a video frame;
performing DCT transformation upon the first pixel block, or upon residual information derived there from, thereby providing a plurality of first DCT coefficients;
selecting DCT filtering parameters associated with said classification information.

19. The method of claim 18, wherein the step of providing classification information comprises determining a level of detail and edginess of said first pixel block.

20. The method of claim 18, further comprising a step of determining a reference informationframe, and deriving residual information from the first pixel block a current frame using the reference informationframe.

21. The method of claim 18, further comprising a step of comparing an estimated transmission rate for codingtransmitting the first macroblock a current frame in an intra mode with an estimated transmission rate for codingtransmitting residual information in an inter mode.

22. The method of claim 18, further comprising a step of selecting, in dependence on estimated transmission rates, to codetransmit either the first macroblock in an intra mode, a current frame, or residual information derived there from in an inter mode.

23. The method of claim 22, in case of transmitting the first macroblock, a current frame, comprising a step of varying the DCT filtering parameters in dependence on the classification information, said classification information indicating the frame's a level of detail and edginess.

24. The method of claim 22, in case of transmitting residual information, comprising a step of varying the extent of DCT filtering in dependence on the classification information, said classification information indicating a level of detail and edginess.
in dependence on how much the transmission rate is reduced when transmitting the residual information instead of the current frame.

25. The method of claim 18, further comprising a step of setting equal to zero all high order DCT coefficients of a DCT coefficient matrix below a diagonal associated with a desired extent of DCT filtering.

26. The method of claim 18, further comprising a step of receiving information indicating whether progressive coding or interlaced coding is used, wherein in case of interlaced coding, the area of high order DCT coefficients that are set to zero is chosen such that different thresholds are utilized for zeroing the vertical and the horizontal DCT coefficients.

27. The method of claim 18, additionally comprising performing DCT transformation upon a second pixel block in the first macroblock of said frame.

28. The method of claim 18, additionally comprising performing DCT transformation upon a first pixel block in a second macroblock of said frame.
